(19) United States
(12) Patent Application Publication
(10) Pub. No.: US 2002/0099652 A1
(43) Pub. Date: Jul. 25, 2002

(54) Electronically transmitted payment system

(75) Inventors: Brian Von Herzen, Carson City, NV (US); Timothy L. Kay, Los Altos, CA (US); Edwin A. Suominen, Phoenix, AZ (US)

Correspondence Address: LOUIS J. HOFFMAN, P.C., Suite 300, 14614 North Kierland Boulevard, Scottsdale, AZ, 85254, US

(73) Assignee: Rapid Prototypes, Inc.

(21) Appl. No.: 09/741,136

(22) Filed: Dec. 15, 2000

Related U.S. Application Data
(60) Provisional application No. 60/129,403, filed on Apr. 15, 1999.
(60) Provisional application No. 60/176,401, filed on Jan. 13, 2000.

(51) Int. Cl. G06F 17/60

(52) U.S. Cl. 705/39; 705/40

(57) ABSTRACT

Methods and systems permit electronic transmission of payment or a rebate to a payee or rebate recipient. The payee or rebate recipient (320) prints a financial instrument (364) or generates a coupon at a printer (360) or user terminal (350). The financial instrument or coupon (364) can be generated without the need for special equipment and can be redeemed for payment at a financial institution of the payee or rebate recipient's choosing.

### PROVISIONAL APPLICATIONS

This application claims benefit of provisional Patent Application Nos. 60/129,403 filed Apr. 15, 1989, and 60/176,401 filed Jan. 13, 2000, both by the above-named inventors. These two applications are both incorporated herein by reference. The detailed description portion (including referenced drawing figures) of any U.S. patent or U.S. patent application incorporated by reference into these aforementioned patent applications is also specifically incorporated herein by reference.

A portion of the disclosure of this patent application contains material that is subject to copyright protection. The copyright owner has no objection to the facsimile reproduction by anyone of this patent document or the patent disclosure as it appears in the Patent and Trademark Office patent file or records, but otherwise reserves all copyright rights.

### BACKGROUND OF THE INVENTION

For centuries, persons have paid for goods and services by physically transmitting a financial instrument to persons providing the goods and services. With the progression of time, earlier types of financial instruments such as coins and gold bullion have been replaced by demand notes such as paper currency, checks, and money orders. However, the basic physical transmission of a financial instrument from a payor to a payee remains a popular form of financial transaction.

This time-honored physical transmission of payment is depicted in FIG. 1, in which a payor 110 physically transmits a financial instrument 120 to a payee 130. A significant benefit of physical payment transmission is that a payor can convey a financial instrument to any desired payee, not just payees who are specially prepared to receive payment. Even if the payee is a random street vendor or day laborer with no relationship to the payor or any particular financial institution, the payor can convey a financial instrument to the payee in exchange for goods or services.

However, physical transmission of a financial instrument requires the payor to be in the same physical space as the payee, or to convey the financial instrument by some sort of physical transport such as the U.S. mail service. As persons have begun to purchase goods and services more and more via electronic commerce, the need has increased for a way to transmit payment electronically.

Various Internet payment schemes have been developed in an attempt to meet this need. However, these payment schemes lack the flexibility offered by the physical transmission of a financial instrument from a payor to any desired payee. With conventional schemes, a payor cannot simply select a desired payee who has no relationship to the payor any particular financial institution and convey payment to that payee. One such scheme, presently offered on the Internet at www.payme.com, requires that payees establish a relationship with a financial institution so that payment can be received electronically into an account maintained by the payee at that particular financial institution. Other such schemes, such as that disclosed in U.S. Pat. No. 5,909,673 to Gregory and that presently offered on the Internet at www.checksbynet.com, require the payee to take special steps to receive electronic payments, including configuring a printer with an expensive, specialized Magnetic Ink Character Recognition (MICR) cartridge.

Consequently, the need remains to provide the flexibility of physical transmission of a financial instrument with the benefits of electronic payment. A payment system is needed that allows a payor to electronically convey a financial instrument to any desired payee, without the need for the payee to either take special steps to prepare for receiving payment or have any prior relationship with the payee or any particular financial institution.

A further need remains for electronic transmission of rebates. Manufacturers' rebates have become commonplace in the competitive retail sales market. By including manufacturer's mail-in rebates in their price quotations, retailers are able to offer low advertised prices. In the consumer electronics market, however, these mail-in rebates are often offered by disreputable manufacturers that do not actually send the rebates to the consumer.

Conventional rebate fulfillment is typically slow and inconvenient to the consumer, even when trustworthiness of the manufacturer is not in question. For example, E-machines (www.e4me.com) offers a $75 rebate on its $474 computer. These rebates commonly take three months or longer to process by mail, and are tedious, time consuming and uncertain.

As a result, customers are generally skeptical and dubious about actually getting offered rebates, and are reluctant to carry out the form filling, cutting, pasting, mailing and waiting required just to get a possible check in the mail months later. Following up to ensure payment requires organization, is still more time consuming, and yet uncertain in its outcome.

Another example of manufacturers' rebates may be found at www.cyberrebate.com. This site offers manufacturers' rebates in exchange for detailed marketing information about products purchased. Even though this site is on the Internet, they still use mail-in rebates. These require the consumer to mail in the product's UPC code as a proof of purchase, along with forms, and wait weeks to receive rebate payment in the form of a check.

### SUMMARY OF THE INVENTION

Methods and systems according to various aspects of the present invention permit electronic transmission of payment or a rebate to a payee or rebate recipient. The payee or rebate recipient prints a financial instrument or generates a coupon at a printer or user terminal. The financial instrument or coupon can be generated without the need for special equipment and can be redeemed for payment at a financial institution of the payee or rebate recipient's choosing.

In one method of the invention for electronically transmitting funds, a payor, payee, or financial intermediary establishes a connection between a first user terminal and a printer on a wide area network. The first user terminal is accessible to the payor, and the printer is accessible to the payee. The printer is configured to print substantially nonmagnetic printing media on a paper medium. Authorization input is provided to the first user terminal to activate the printer so that it prints a financial instrument on the paper medium.

By printing the financial instrument on a paper medium with substantially nonmagnetic printing media, the need for an expensive, specialized MICR cartridge is avoided. Consequently, any payee having access to a plain paper printer or fax machine can print the financial instrument.

Another method of the invention for electronically transmitting funds includes designating an electronic mail address of a payee and conveying an electronic mail message to the payee. The message includes an authorization code. Responsive to the authorization code, printing of a financial instrument is activated on a printer accessible to the payee. Advantageously, an authorization code can be transmitted via an electronic mail message to any designated payee having an electronic mail address.

The financial instrument printed in the methods includes indicia of a financial account and an amount of funds that the payee is authorized to draw from the financial account. The indicia can further identify the payee or an entity that owns funds of the financial account, or both, and can include contact information for an authorized agent of the entity. To help deter fraud, the financial instrument can include security markings that are configured to change appearance when optically duplicated.

To further deter fraud, a particularly advantageous variation of the methods also includes maintaining an issue list. An issue list is any list of payments of funds that one or more payees are authorized to draw, and have not yet drawn, from funds of the payor in the financial account. After presentation of the financial instrument to a financial institution in such a variation, the payee is only permitted to draw the funds indicated by the financial instrument if the list indicates that the payee is authorized to draw the funds and has not yet drawn them.

To help assure the payee of the validity of payment, another advantageous variation of the methods includes coupling a server of an intermediary entity to the network. In such a variation, an authorization code is transmitted from the first user terminal to the second user terminal to signify payment of funds from the payor to the payee. The authorization code is relayed from the second user terminal to the server to signify acceptance of payment by the payee. Upon acceptance of the authorization code by the intermediary entity, the financial instrument is printed under control of the server.

Software can be downloaded from the server of the intermediary entity to control printing of the financial instrument. Advantageously, the software can be configured to allow only a single copy of the financial instrument to be printed on the printer.

Electronic activation (i.e., generation) of a rebate coupon according to various aspects of the present invention provides rebate remittance with convenience, speed, and consumer protection. By permitting a rebate provider to electronically authorize generation of a coupon when a user has met predetermined fulfillment obligations, such a system avoids the delay and uncertainty associated with mail-in rebates. The user is assured of payment as soon as the rebate coupon is generated.

By providing a more user-friendly rebate system, the invention makes it easier for manufacturers to encourage consumers to register their products. Consequently, manufacturers can more readily obtain demographic information.

In a method of the present invention for electronically transmitting a rebate, a rebate provider offers a rebate to a user operating a user terminal. The rebate provider offers the rebate, either directly through a network connection, through a financial intermediary, or indirectly through computer software that the rebate provider delivers to the user, in consideration for performance of an obligation of a specified rebate transaction. Software executing on the user terminal, a server of the rebate provider or financial intermediary, or another type of controlling entity receives information from the user terminal confirming performance of the obligation. Upon performance of the obligation, the controlling entity permits a rebate coupon to be generated at the user terminal. The rebate coupon includes a medium bearing trusted indicia of payment obligation to the bearer of the medium.

Advantageously, the rebate coupon can be printed on a plain paper medium with substantially nonmagnetic printing media, avoiding the need for a specialized printer Consequently, any rebate recipient having access to a plain paper printer or fax machine can print the rebate.

The rebate provider can offer the rebate as an incentive for the user to agree to accept specific terms for use of a product or service. To perform the obligation of such a rebate transaction, the user performs an action intended to legally bind the user to the agreement. A particularly convenient type of action requires the user to remove opaque material to reveal a code printed on a tangible medium. The user can enter the exposed code to obtain the rebate, at the expense of signifying that he or she agrees to be legally bound by the specific terms of the rebate transaction.

According to one aspect of the invention, a coupon is only activated when a user performs obligations of a rebate transaction that extend for a predetermined period of time, for example to ensure that a user remains subscribed to a fee-based service for sufficient time to justify providing a rebate.

According to another aspect of the invention, a coupon is only activated when a user agrees to waive return of a product. Consequently, manufacturers can be more assured of making a final sale of a product. Software manufacturers can avoid fraud without the need for “no return if opened” policies.

According to another aspect of the invention, software manufacturers can provide an immediate incentive for users to install their brand of a software product.

According to still another aspect of the invention, polling agencies can provide members of a survey sample an incentive to respond to a survey. By offering a rebate for a realistic survey response (e.g., all radio buttons of an Internet survey selected from default positions, non-outlier responses to questions, etc.), a polling agency can obtain more responses to inquiries than if no compensation were offered.

Other advantageous aspects of the present invention are disclosed in the detailed description below, some of which are particularly pointed out in the appended claims.

### BRIEF DESCRIPTION OF THE DRAWING

Various embodiments of the present invention are described below with reference to the drawing, wherein like designations denote like elements.

FIG. 1 is a representative view of a payor and payee engaged in conventional transmission of a financial instrument.

FIG. 2 is a representative view of a payor and payee engaged in electronic transmission of a financial instrument according to various aspects of the present invention.

FIG. 3 is a representative view of a exemplary system for transmitting payment from a payor to a payee via a global communications network.

FIG. 4 is a block diagram of a user terminal usable with an embodiment of the invention showing processes performed by the terminal.

FIG. 5 is a block diagram of a server usable with an embodiment of the invention showing processes performed by the server.

FIG. 6 is a diagram of data flow and funds transfers in accordance with an embodiment of the invention.

FIG. 7 is an alternative diagram of data flow and funds transfers in accordance with an embodiment of the invention.

FIG. 8 shows a data structure of an electronic mail usable with an embodiment of the invention.

FIG. 9 is an alternative data structure of an electronic mail usable with an embodiment of the invention.

FIG. 10 is an exemplary page displayable on the world wide web for soliciting use of a money-order system in accordance with an embodiment of the invention.

FIG. 11 is the second page of FIG. 10.

FIG. 12 is an exemplary financial instrument printed in accordance with the invention.

FIG. 13 is a flowchart depicting a method of transmitting payment from a payor to a payee in accordance with an embodiment of the invention.

FIG. 14 is a flowchart depicting another method of transmitting payment form a payor to a payee in accordance with another embodiment of the invention.

FIG. 15 is a flowchart depicting a method for printing a financial instrument at the payee's location in accordance with aspects of the invention.

FIG. 16 is a flowchart depicting methods for payment of a printed financial instrument when presented by the payee, in accordance with the invention.

FIG. 17 is a diagram of a rebate activation system in accordance with an embodiment of the invention.

FIG. 18 is a block diagram of a computer system usable with FIG. 17 showing processes performed by the computer system.

FIG. 19 is a diagram showing an exemplary process for transfer of funds in a rebate system using an issue list.

### DESCRIPTION OF PREFERRED EXEMPLARY EMBODIMENTS

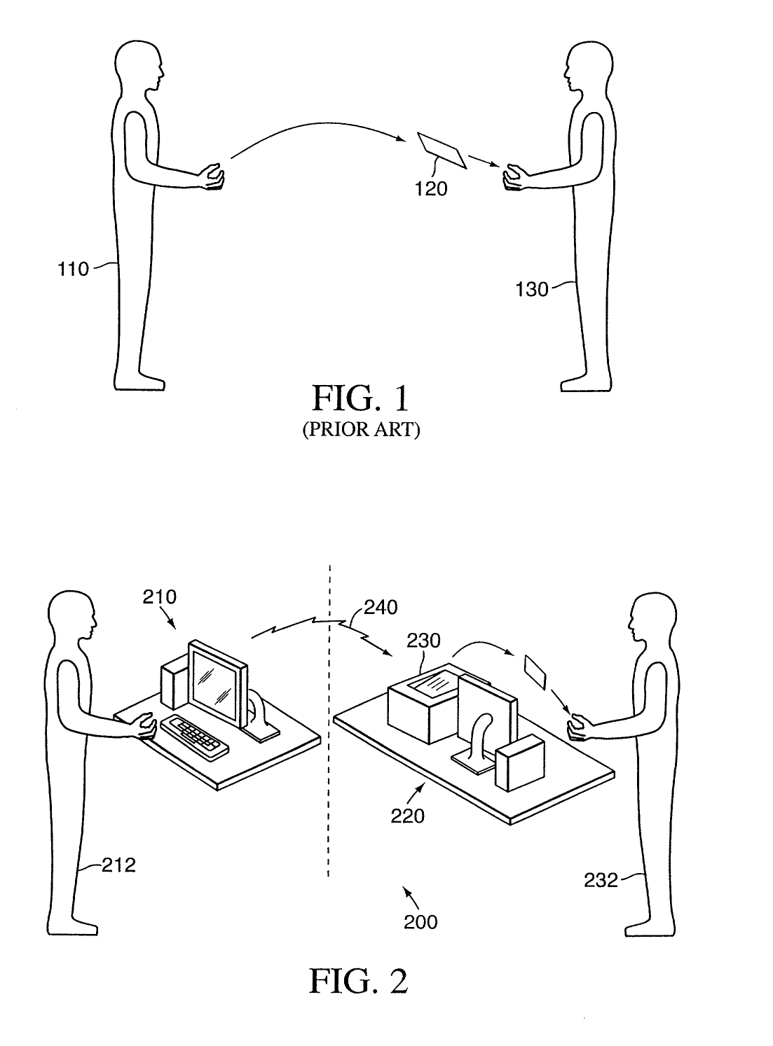

Electronic transmission of payments according to various aspects of the present invention provides numerous benefits, including allowing a payor to electronically convey a financial instrument to any desired payee. The payee does not need to take special steps to prepare for receiving payment or have a prior relationship with the payee or any particular financial institution. A system according to various aspects of the invention for electronic payment transmission can be implemented by any suitable combination of hardware and software. For example, system 200 of FIG. 2 includes a first user terminal 210 accessible to a payor 212 and a second user terminal 220 and a printer 230 that are accessible to a payee 232. A connection is established between terminal 210 and printer 230 (through terminal 220) on a wide area network, which is schematically represented by signal 240. Payor 212 can transmit payment to payee 232 by providing suitable authorization input to terminal 210. Second user terminal 220 activates printer 230 responsive to the authorization input to print a financial instrument 250, which payee 232 can redeem at a financial institution for payment.

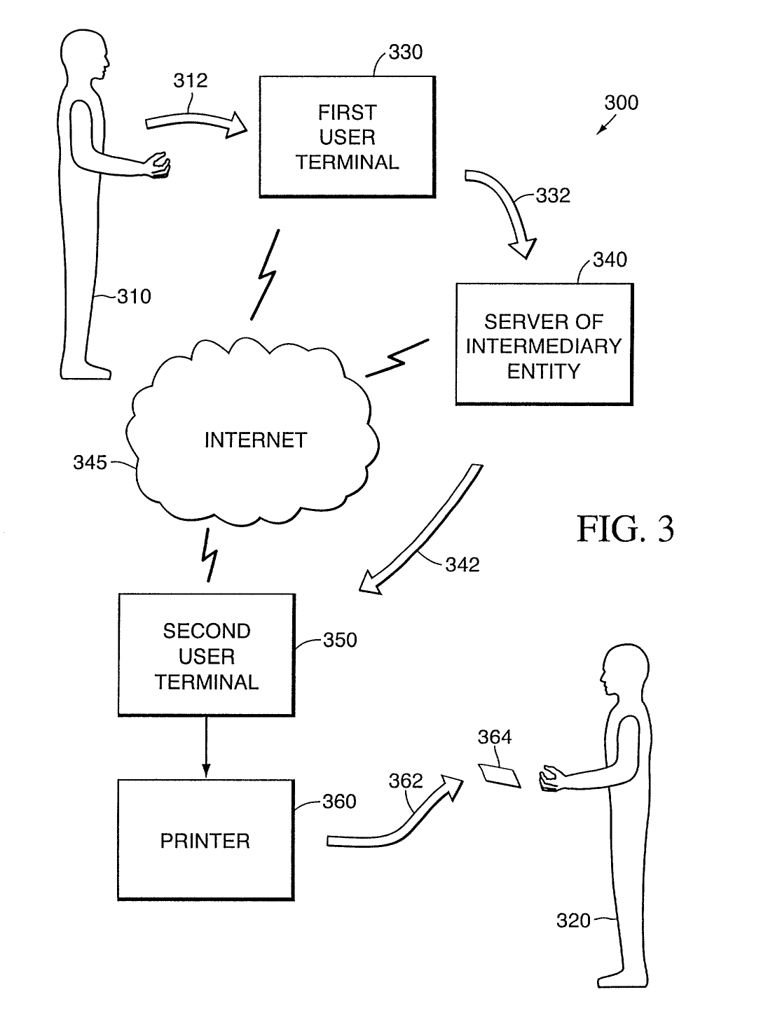

Advantageously, the financial instrument can be transmitted to a payee via the Internet. An exemplary system 300 for transmitting payment from a payor 310 to a payee 320 via the Internet may be better understood with reference to FIG. 3. System 300 includes a first user terminal 330, a server 340 of an intermediary entity, a second user terminal 350, and a printer 360. First user terminal 330, server 340, second user terminal 350, are coupled together via a network connection established on the Internet 360, represented by a cloud symbol. Printer 360 is coupled to terminal 330 and server 340 through terminal 350.

Payor 310 authorizes transmission of payment to payee 320 through terminal 330, the flow of authorized funds being represented by arrow 312. Payment effectively passes from terminal 330 to server 340, as represented by arrow 332. Payment effectively passes from server 340 to second user terminal 350, as represented by arrow 342. Terminal 350 activates printer 360 to print a financial instrument 364, which is received by payee 320. This final flow of funds is represented by arrow 362.

The actual transfer of funds to payee 320 represented by arrow 362 does not take place until payee 320 presents financial instrument 364 to a financial institution for payment. However, system 300 may transfer some funds before that time, for example as an Automated Clearing House (ACH) transaction between financial institutions of payor 310 and intermediary entity of server 340, conducted via the Internet 360.

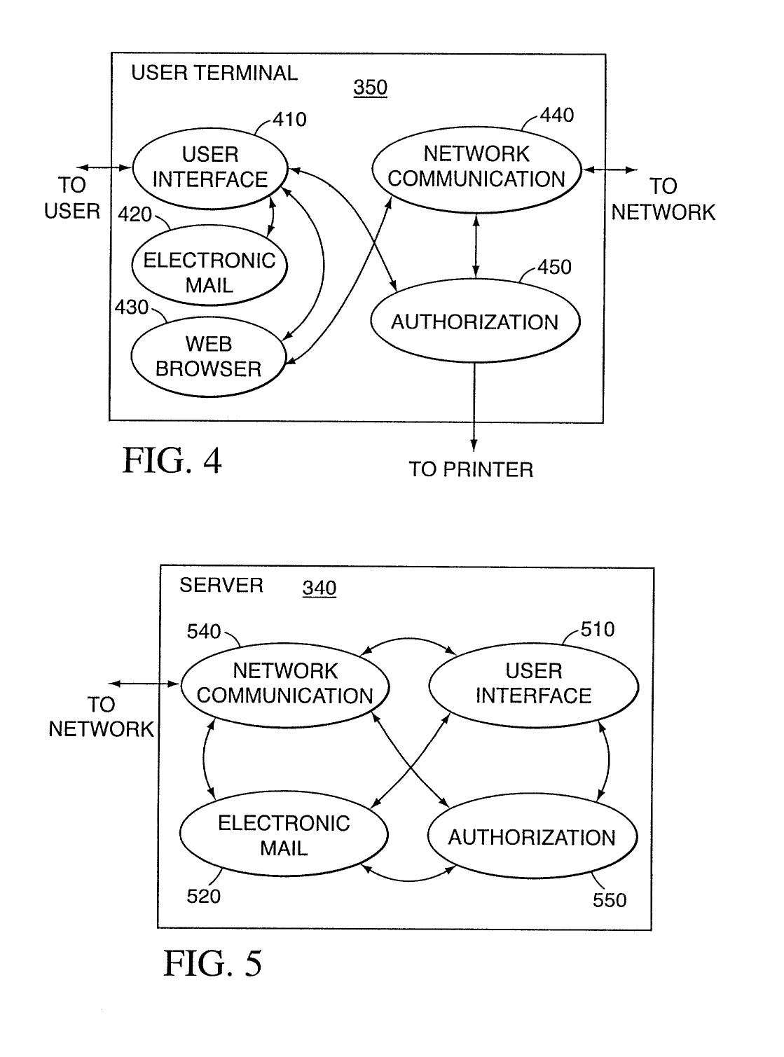

A user terminal according to various aspects of the present invention includes any suitable hardware or software, or combination thereof, that can be accessed by a user for communication of information to or from a network. For example, user terminal 350 includes hardware and software that carries out various processes depicted in FIG. 4. Hardware of user terminal 350 can include various components of a conventional PC-compatible computer. Software of user terminal 350 can include a WINDOWS 98 (RTM Microsoft Corp.) or Linux operating system.

The various processes depicted in FIG. 4 effectively create subsystems within terminal 350. These processes include a user interface 410, electronic mail 420, a web browser 430, network communication 440, and authorization 450. User interface 410 displays information to a user and receives input from the user, and exchanges information and input with electronic mail process 420 and web browser process 430. Electronic mail process 420, which can be implemented by conventional software such as NETSCAPE Messenger (RTM Netscape Communications Corp.) or MICROSOFT Outlook (RTM Microsoft) cooperates with user interface 410 and network communications process 440 to permit the user to send and receive electronic mail messages. Web browser process 430, which can be implemented by conventional software such as NETSCAPE Navigator or MICROSOFT Internet Explorer, cooperates with user interface 410 and network communications process 440 to permit the user to view web pages, send information via web-based forms and encoded URLs, and download files.

Network communication process 440 is of any suitable type for communicating information to or from a network. In a variation of user terminal 350 where the network is the Internet and the network connection is through audio telephone signals, process 440 can be carried out by a modem and dial-up networking software of the WINDOWS 98 operating system. In a variation where the network connection is through Digital Subscriber Loop (DSL) telephone signals, network communication process 440 can be carried out by a DSL adapter card and Ethernet software. In other variations, a user terminal can communicate information to or from a network other than the Internet, using other types of network connections.

Authorization process 450 controls printing of a financial instrument responsive to an authorization code or software received through network communication process 440.

First user terminal 310 can include the same hardware and software of second user terminal 350. This hardware and software can carry out the processes depicted in FIG. 4, though terminal 310 does not require all of those processes to implement system 300. For example, user 310 can authorize transmission of funds using either a web browser or, in a different embodiment, an electronic mail message. Thus, first user terminal 310 does not necessarily need to carry out both an electronic mail process and a Web browser process.

In addition, authorization process 450 may be different in first user terminal 310 than in second user terminal 350, or even omitted. Terminal 310 does not necessarily need to authorize printing to any attached printer to implement system 300 because financial instrument 364 is printed on printer 360, which is controlled by second user terminal 350. In variations of first user terminal 310, authorization process 450 can include functions of attaching computer executable code to an electronic mail message, or generating a password or URL for embedding in a message to a payee, only when payment is authorized.

Exemplary system 300 includes server 340 of an intermediary entity. An intermediary entity according to various aspects of the present invention includes any company, person, or organization that accepts funds from a payor and transmits funds to a payee so that the funds are effectively transmitted from the payor to the payee through the intermediary entity. An intermediary entity can offer a guarantee to the payee that assures the payment even if the payor defaults in funds paid to the intermediary entity. Such a guarantee can make a payee more likely to accept payment using system 300 even if the payee has never used such a system before. The credibility of the guarantee can be enhanced when the payee recognizes a brand name of the intermediary entity and associates that name with financial reliability.

In a variation where the benefits of an intermediary entity are not required, it can be omitted. When system 300 is configured in such a variation, payment of funds proceeds directly from first user terminal 330 to second user terminal 350.

A server according to various aspects of the present invention, such as server 340, includes any suitable hardware and/or software that can exchange information with a user terminal via a network. Server 340 includes hardware and software that carries out various processes depicted in FIG. 5. Hardware of server 340 can include various components of a PC-compatible computer, suitably configured for the demanding reliability and performance requirements of a server. Software of server 340 can include a WINDOWS NT (RTM Microsoft Corp.) or Linux operating system.

The various processes depicted in FIG. 5 effectively create subsystems within server 340. These processes include a user interface 510, electronic mail 520, network communication 540, and authorization 550. User interface 510 transmits information to a user (e.g., HTML for display on a web browser at a user terminal) and receives input (e.g., form posting) from the user. Electronic mail process 520 is an automated electronic mail processor that sends electronic mail messages, authorization codes, and printing software to payees to advise of proffered payment and control printing of financial instruments. Authorization process 550 interacts with electronic mail process 520 to control the sending of authorization codes and printing software to payees.

To carry out processes 510, 520, and 550, software of server 340 can further include a CGI script. A suitable script is appendixed to this patent application in ten pages of program listing and incorporated herein by reference. A description of this script's functions is provided in TABLE I below.

TABLE I

| Function | Description |
|---|---|
| main | Connects to online database of financial |
| | intermediary |
| go | Branches to the appropriate function based on the |
| | action query. |
| lookup_ebay | For integration with payment related to an auction |
| | service (www.eBay.com)-looks up auction |
| | information on the eBay website. |
| have_info | Gets the payor and payee (buyer and seller, |
| | respectively) name and address information and |
| | email |
| from_mol | Processes the credit card merchant information for |
| | payment, and provides email messages. |
| from_email | Responds to payer and payee visits from clicking |
| | on their email activation code |
| choice | Lets the payee choose between accepting the money |
| | order or not, and having it printed using |
| | the inventive system or mailed |
| download | Sends the money order software and related indicia |
| | to payee's user terminal. |
| sendmail | Facilitates the transmission of email to the payor |
| | and payee (buyer and seller). |
| retrieve_ebay_info | For integration with payment related to an auction |
| | service (www.eBay.com)-gets auction information |
| | from the eBay website. |
| print_file_hinted | Prints header information. |
| print_header | Provides content type for web page generation. |
| load_file | Reads a file into server memory |
| subst | Substitutes one string for another in a record |
| quote | Inserts quotes around operands |
| parse_query | Processes key and value fields in a table database |
| today | Retrieves the day of the year |
| get | Gets a connection to the database |
| encode | Performs a ROT encryption translation of data |

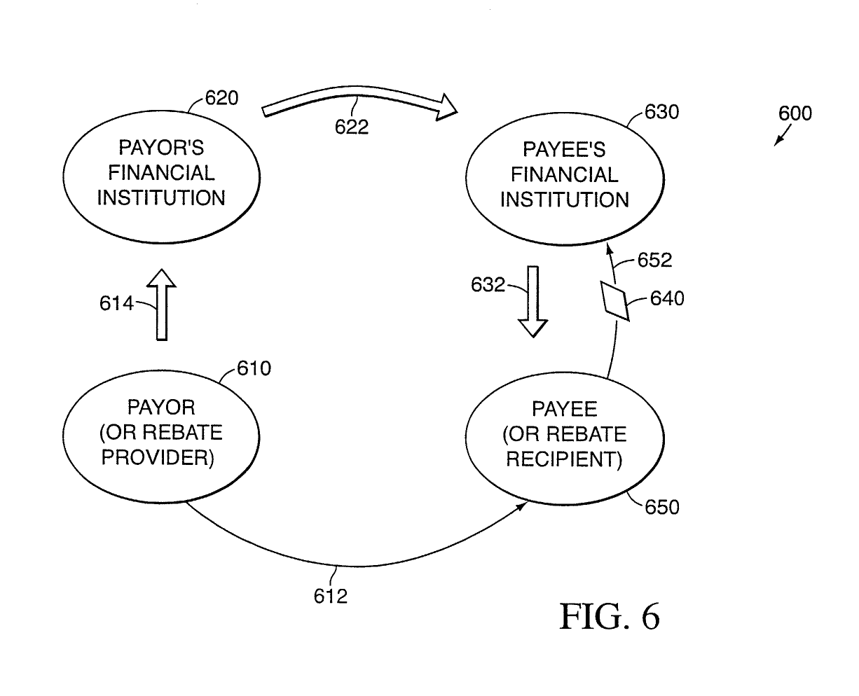

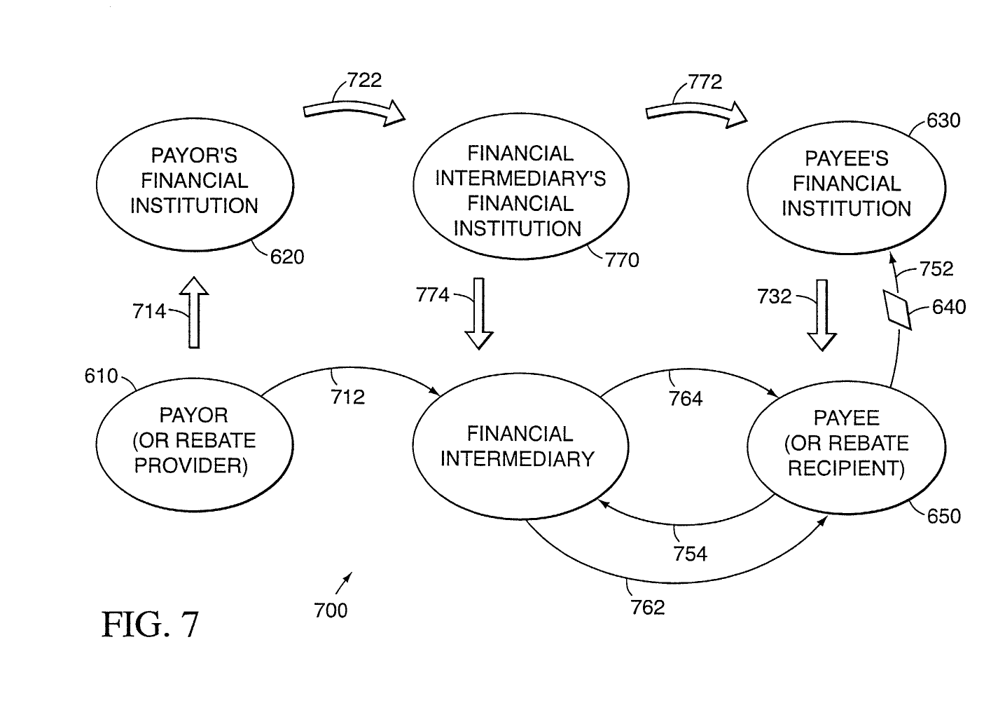

Electronic transmission of funds according to various aspects of the present invention, such as that performed by system 300 of FIG. 3, may be better understood with reference to data flow diagrams of FIGS. 6 and 7.

FIG. 6 is a diagram of data flow (and funds transfer) in a transaction 600 that does not involve a financial intermediary. In transaction 600, a payor 610 initiates payment to a payee 650 by entering a suitable type of authorization input, which is then transmitted electronically to payee 650 as an authorization code. (This transmission is represented in FIG. 6 by line 612.) The transmission can take the form of an electronic mail message from payor 610 to payee 650, in which case the authorization code can be added to the message as a password or embedded URL, or attached a portion of computer executable code attached to the message.

When transaction 600 is carried out in system 300 (minus unused server 340), authorization process 450 in user terminal 310 can cooperate with user interface process 410 to help the payor send the authorization code in an electronic mail message. For example, authorization process 450 can generate an executable program for a PC compatible computer that includes information on the payer's account number, item number, payor information and payment amount. The executable can be attached to the message and transmitted along with an introductory message in the body of the message.

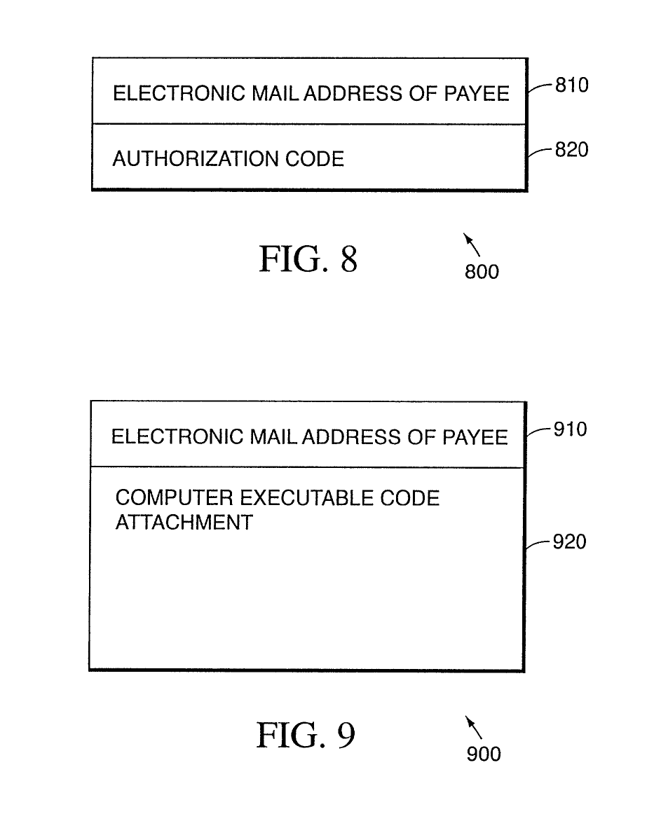

An electronic mail message sent from payor 610 to payee 650 to signify a payment of funds is a type of data structure. FIG. 8 depicts a data structure 800 of one type of electronic mail message for transmitting the authorization code in transaction 600. Data structure 800 includes an electronic mail address of the payee, for example in the form user@domain.com. Structure 800 further includes the authorization code 820, which is incorporated into the body of the electronic mail message as a password or embedded URL. When code 820 is embedded as a password, the body of the message may include text of the type in TABLE II below:

TABLE II

| Type of Payment | Example Message Text |
|---|---|
| Money order or personal | “John Doe has made a payment of $100.00 |
| check from buyer to seller | available for you. To accept and receive |
| | this payment, enter the password ‘a1b2c3d4’ |
| | at www.moneyordersonline.com. |
| | You will then be able to print a |
| | check for the amount of |
| | payment using your web browser and |
| | printer.” |
| Government check | “You are entitled to a $1,000 refund on |
| | your withheld federal income taxes. To |
| | receive your refund electronically, simply |
| | enter the password ‘a1b2c3d4’ at |
| | www.refundwebsite.com. You will then be |
| | able to print a check from |
| | the U.S. government for your refund using |
| | your printer.” |
| Rebate coupon | “Congratulations on your purchase of |
| | an ACME software product and your rebate |
| | of $10.00. To receive your rebate, |
| | enter the password ‘a1b2c3d4’ in the ‘help- |
| | rebate’ menu of your new software. You will |
| | then be able to print a check for the |
| | rebate using your printer.” |
| Traveler's check | “Thank you for your purchase of $500 |
| | worth of ACME traveler's checks. To |
| | receive the four $100 checks and |
| | five $20 checks you selected, enter |
| | the password ‘a1b2c3d4’ at |
| | www.acmetravelerschecks.com. You will |
| | then be able to print your checks using |
| | your web browser and printer.” |

Upon receipt of the authorization code, payee 650 is able to print financial instrument 640 on a printer accessible to him or her. As discussed below, suitable types of financial instruments include personal checks, traveler's checks, money orders, and rebate coupons. Payee 650 presents financial instrument 640 to a financial institution of payee's choice for payment. (This physical transmission is represented in FIG. 6 by line 652.)

Funds transfer in transaction 600 is represented in FIG. 6 by arrows 622 and 632. Arrow 632 represents the funds transfer of payee 650 receiving funds (as cash or a deposit to the payee's financial account). Arrow 622 represents the consequent funds transfer from the payor's financial institution 620 to the payee's financial institutions 630. Arrow 614 represents the charge or debit incurred by payor 610 for the payment.

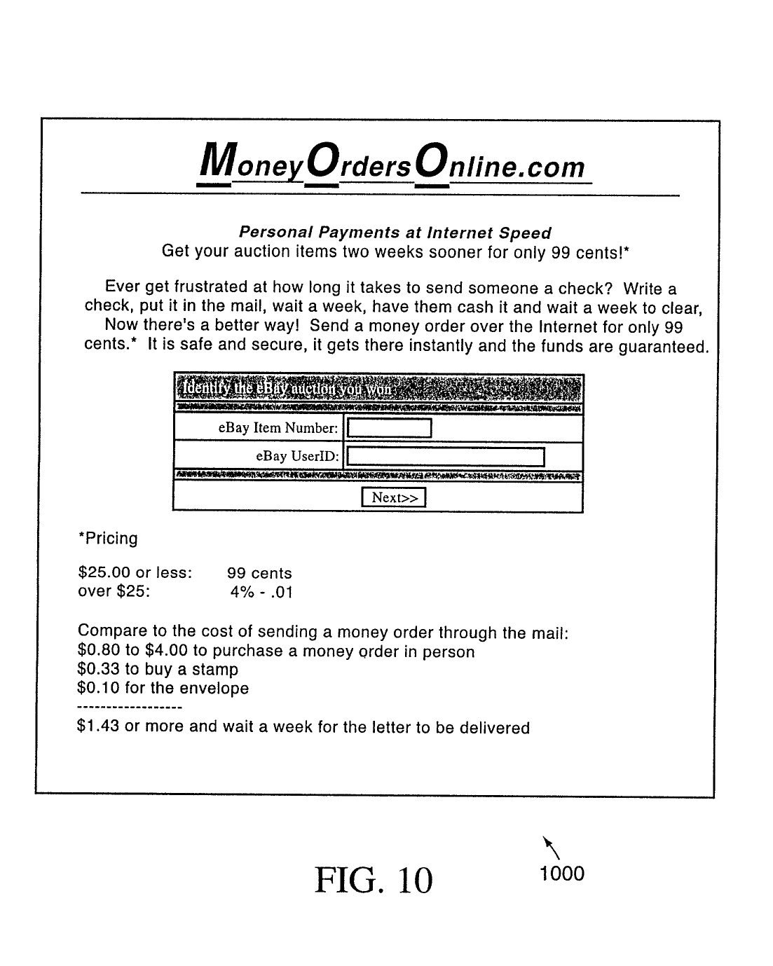

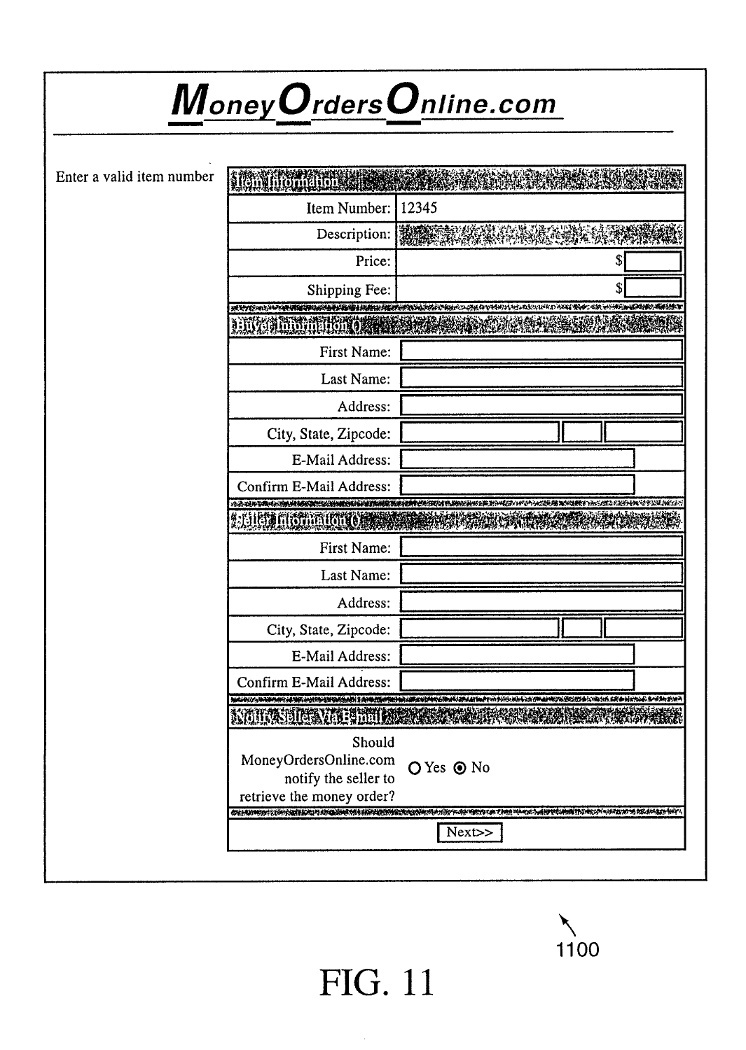

FIG. 7 is a diagram of data flow (and funds transfer) in a transaction 700 that is similar to transaction 600, but involving a financial intermediary. In transaction 700, payor 610 initiates payment to payee 650 by entering a suitable type of authorization input, which is then transmitted electronically to financial intermediary 710. (This transmission is represented in FIG. 7 by line 712.) The transmission can take the form of form input to web pages served by a server of financial intermediary 710, such as server 340 of system 300. Examples of such web pages are depicted in FIGS. 10 and 11.

After receiving authorization input from payor 610, the server of financial intermediary 710 alerts payee 650 as to the availability of payment and electronically authorizes printing of a financial instrument for the amount of payment. Financial intermediary 710 can also offer a guarantee of the payment to encourage payee 650 to accept it. (The transmission of this alert and optional offer of a guarantee is represented in FIG. 7 by line 762.)

The alert, authorization, and offer of a guarantee can all be transmitted via an electronic mail message from payor 610 to payee 650. The authorization can take the form of an authorization code. The transmission of such a code via an electronic mail message is discussed above with reference to FIG. 6 and TABLE II. Other types of electronic transmission can be employed, such as “push” browser technlogy, fax, or the “Instant Messaging” services presently marketed by AMERICA ONLINE and NETSCAPE.

If payee 650 wishes to accept the payment, he or she performs an appropriate action to indicate acceptance and activate printing of financial instrument 640. For example, payee 650 can log onto the internet web site of financial intermediary 710 with an embedded URL (and, if asked, affirm acceptance of payment). The server of financial intermediary 710 can require that payee 650 provide the authorization code or other suitable authentication before it will allow printing of financial instrument 640.

The server of financial intermediary 710 sends suitable control information to payee 650, as represented by line 764. Payee then can print financial instrument 640 and present it to payee's financial institution 630 for payment (line 752), as in transaction 600.

Funds transfer in transaction 700 is represented in FIG. 7 by arrows 722, 772, 774, and 732. Arrow 732 represents the funds transfer of payee 650 receiving funds (as cash or a deposit to the payee's financial account). Arrow 772 represents the consequent funds transfer from the financial institution 770 of financial intermediary 710 to the payee's financial institution 630. Arrow 722 represents the funds transfer, resulting from transfer 772, from the payor's financial institution 620 to the financial intermediary's financial institution 770. Arrow 774 represents the profit earned by financial intermediary 770 from the transaction, which is depicted in FIG. 7 as a funds transfer from the financial institution 770 of financial intermediary 710 to financial intermediary 770. Arrow 714 represents the charge or debit incurred by payor 610 for the payment.

As illustrated in FIGS. 10, 11 and in the appendixed code, a financial intermediary can integrate electronic transmission of payment with an online auction service such as that offered by www.ebay.com.

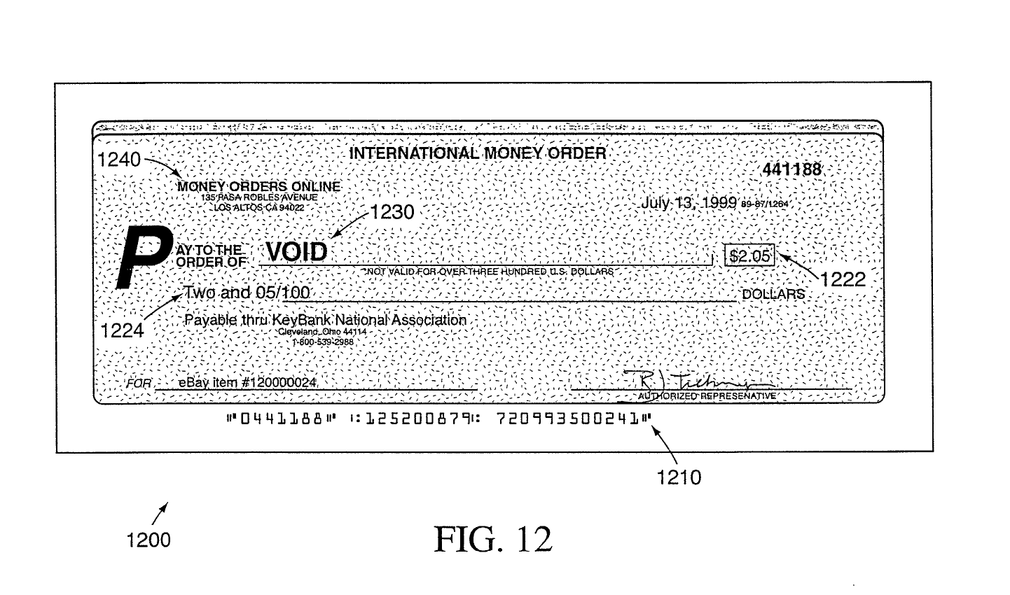

A financial instrument according to various aspects of the present invention includes any suitable indicia on a paper medium for conveying payment to the designated payee or bearer of the instrument. An exemplary financial instrument 1200 is illustrated in FIG. 12. Instrument 1200 includes indicia 1210 of the depository financial institution and account number of the sender of the financial instrument. The financial instrument includes the amount of the payment written numerically 1222 and also in textual format 1224. It can include the the name 1230 of the recipient or payee (voided in the case of FIG. 12) and also the name 1240 and address or contact information of the intermediary or of the sender who owns the financial account at the depository financial institution.

The financial instrument 1200 can be printed on a plain paper medium such as standard office paper. It can also comprise an incentive instrument or rebate coupon that is provided as compensation for completing a desired activity or task. The financial instrument may further comprise a personal check, traveler's check or money order. In addition, the financial instrument may contain security markings that are configured to change appearance when optically duplicated. Examples of these markings can be found in blank check stock that can be purchased at office supply stores containing pantographs that change appearance when optically duplicated.

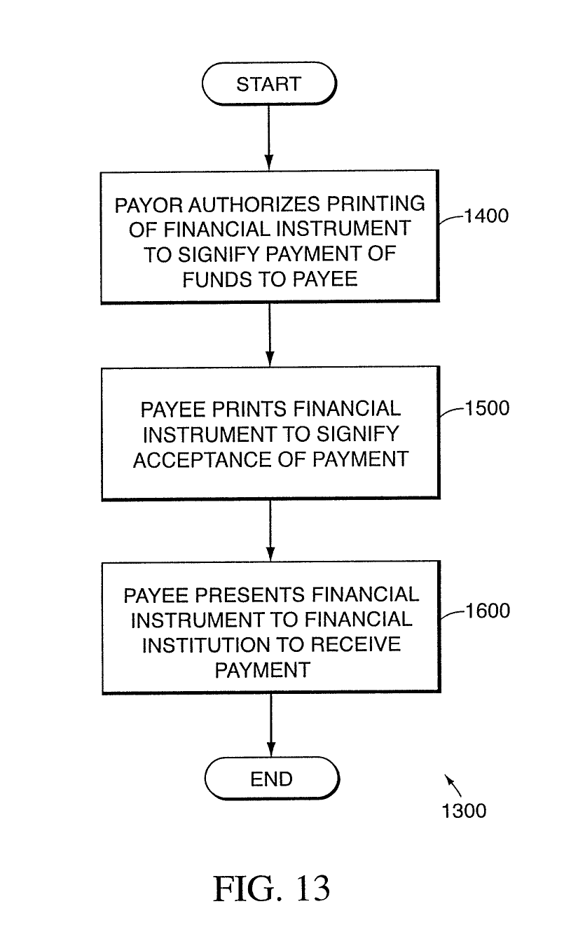

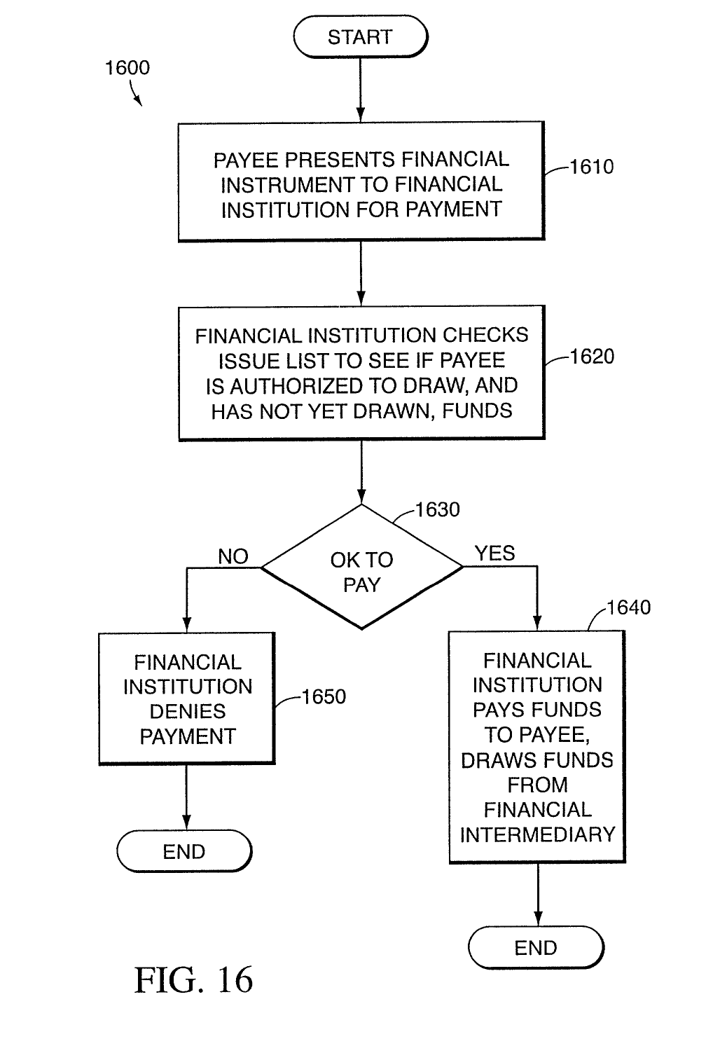

An exemplary method for transmitting payment from a payor to a payee may be better understood with reference to FIGS. 13-16. Method 1300 of FIG. 13 begins with process 1400, in which a payor authorizes printing of a financial instrument to signify payment of funds to a payee. Method 1300 continues with process 1500, in which the payee prints a financial instrument to signify acceptance of payment from the payor. Method 1600 finishes with process 1600, in which the payee presents the printed financial instrument to a financial institution of his or her choice to receive the payment.

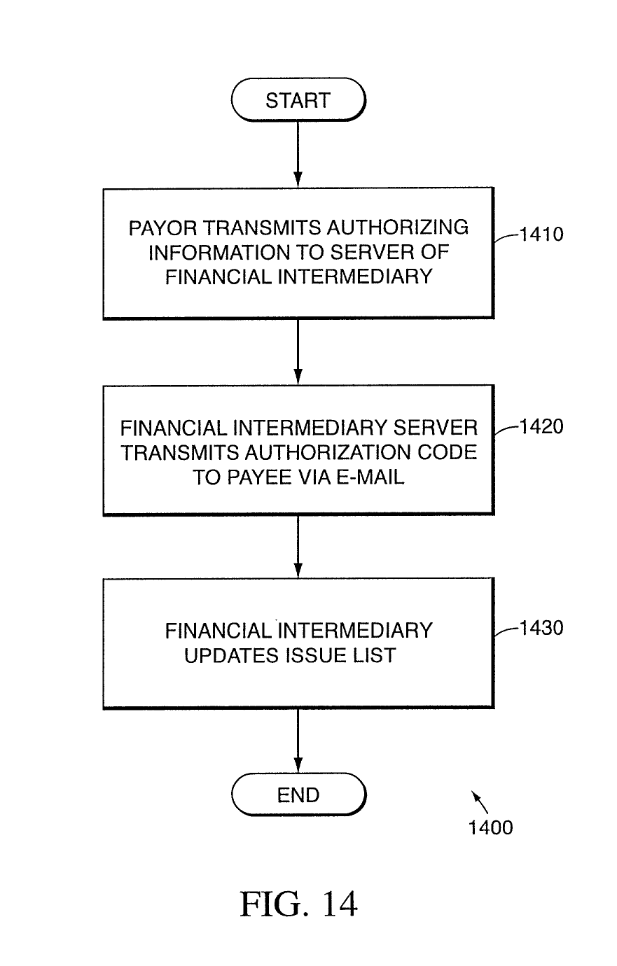

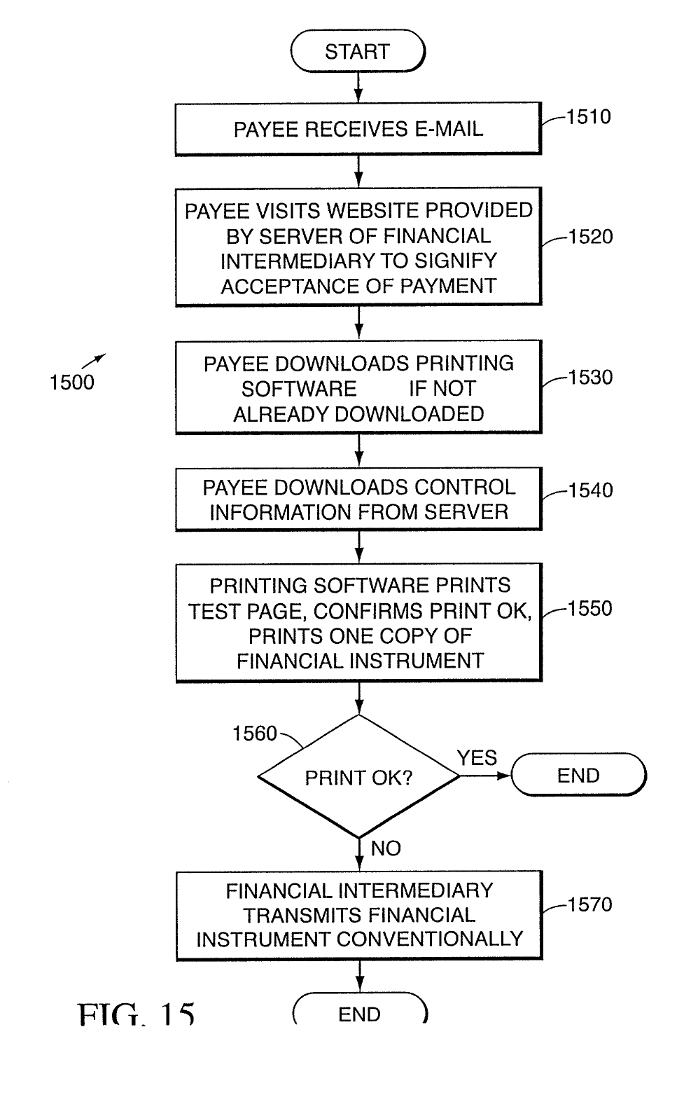

Process 1400 (FIG. 14) begins at step 1410, where the payor transmits authorizing information to the server of the financial intermediary. (This transmission is similar to the transmission represented by line 712 in FIG. 7.) The payor can visit a website of the server and fill out forms such as those depicted in FIGS. 10 and 11. In one embodiment, the forms request the payor's name, email and physical address, and the name, email and address of the payee. In a variation where the payor releases the financial instrument to be sent without this ancillary information, only the payee's email address may be required.

The payor then can provide payment and optional auction information. The payment information can include the payment amount, desired date of payment, and the desired delivery method. The delivery method can include email delivery, web delivery, and (in the event that printing of the financial instrument is not performed), postal service delivery or ACH transfer. If the payment is tied to an Internet auction, the auction information can be supplied, which is then looked up on the auction site, providing final bid price, auction title and descriptive information, along with buyer (payor) and seller (payee) information.

Once the payor has provided the required pricing information, the method of payment from the payor to the financial intermediary is selected. Possible payment methods include credit card, electronic check or ACH (automated clearing house) transactions. The transaction is preferably completed over a secure SSL Internet connection, with the payment authorization being requested over the Internet.

At process step 1420, the server of the financial intermediary transmits an authorization code to the payee via an electronic mail message. At step 1430, the server (or user terminal of the payee) updates an issue list, which is accessible to financial institutions. When a financial institution is asked to clear a financial instrument printed by the payee in the transaction, it can looks confirm that the payee is authorized to draw, and has not yet drawn, the funds designated.

Method 1300 continues with process 1500, in which the payee prints a financial instrument to signify acceptance of payment from the payor. Process 1500 (FIG. 15) begins at step 1510, where the payee receives an electronic mail message from the financial intermediary. The recipient can then visit a Web site provided by a server of the financial intermediary, at step 1520, using a standard Internet web browser.

In one embodiment, the recipient receives email that they have a financial instrument waiting. The recipient follows an embedded URL to the site to receive the financial instrument waiting for them on the server. The recipient selects between U.S. postal service delivery, electronic delivery in accordance with, or to refuse delivery of the financial instrument. If the benefits of electronic transmission are not required and USPS delivery is selected, the financial instrument is printed at a regional distribution office and is sent overnight to the recipient. If the recipient does not accept the financial instrument, they can refuse it. Finally, the recipient can select electronic delivery of the financial instrument in accordance with the invention.

If the recipient has not previously downloaded a financial instrument according to the invention, printing software is downloaded to the computer that enables printing of the financial instrument securely, at step 1530. Then control information for printing the actual financial instrument is downloaded, at step 1540. At step 1550, the printing software prints a test page on the recipient's general-purpose printer, then after the payee confirms that it printed acceptably (at decision step 1560), prints one copy of the financial instrument and ends process 1500. If the financial instrument does not print, the financial intermediary prints the financial instrument and sends it to the payee conventionally, at step 1570. (Suitable positive-pay security precautions should be implemented to prevent fraud.)

Method 1300 finishes with process 1600, in which the payee presents the printed financial instrument to a financial institution of his or her choice to receive the payment. The financial instrument can then be deposited with the recipient's financial institution as with any check or other item. The financial instrument is deposited and passes through the central banking clearing system. In one embodiment, positive pay technology is utilized whereby the item number, recipient and item amount are pre-transmitted to the financial institution. At step 1620, the financial institution checks the issue list to see if the payee is authorized to draw, and has not yet drawn, the funds. The financial institution can have instructions to only accept those items that match all of these parameters. This approach effectively deters fraud by stopping items that do not have matching parameters.

If at decision step 1630 it is determined that payment is acceptable and no fraud is being committed, the financial institution pays the funds to the payee, at step 1640. If not, the financial institution denies payment, at step 1650.

There are several steps involved in actually printing the financial instrument on the payee's general purpose printer. The recipient typically will receive an electronic message providing a URL and authorization information for receiving their financial instrument. The URL points to an Internet website that confirms the identity of the recipient and asks how they would like to receive their financial instrument. If they choose to print the financial instrument themselves, they can indicate this information on the confirmation page. Once confirmed, the recipient downloads the printing software from the Internet server. This software only needs to be downloaded once. After the first download the software installs itself and recognizes the download type for future printing of financial instruments.

The software downloads and is run to setup the printing software. Once the download is complete, the financial instrument is downloaded, with all of the parameters required for printing. Once the financial instrument download is complete, the printing software starts up and processes the financial instrument information. The download software asks the recipient if they want to print a test page to confirm operation of the printer. The test page prints and verifies correct operation by printing a facsimile of the financial instrument that has been voided, in one embodiment. Once the test page prints correctly, the printing software prepares a printing dialog box that, in one embodiment, permits only one printing of the financial instrument. This dialog box is produced using optional parameters to the operating system software for printing control.

In an alternative embodiment, the financial instrument can be printed multiple times. However, if the financial instrument needs to be printed more than once, a warning box appears indicating that the item will only be honored once, and that multiple submissions of the item constitutes fraud and will result in stopped item fees, other bank fees and possible criminal prosecution. In this way, honest printing mistakes can be fixed, while fraudulent activity is warned against and can be stopped using security measures at the participating financial institution.

Once the financial instrument is printed on the general purpose printer, a dialog box appears asking if the financial instrument printed correctly. If it did, then the printing software terminates. If it did not print correctly, and if the software is only authorized to print once, the recipient is directed to customer service, where the financial instrument can be sent via fax, US mail, or ACH (automated clearing house) deposit. In this way, secure transmission of the financial instrument is facilitated.

Any suitable software can be used to print the financial instrument. Over the internet an exemplary printing program queries the server for authorization to print the financial instrument. In response to the query, the server increments a counter, keeping track of the number of times an attempt has been made to print the document. If the number of times exceeds the specified threshold, then the does not authorize printing and the customer is directed to customer service.

The printing program can be improved by certain security precautions. Often people will attempt to get past security using breakpoints. They will let the program progress to a certain dialog box, and set a breakpoint at that location in the program and try to step over the branching conditional of the security check. Then depending on which branch is taken, the program either prints the financial instrument or fails the authorization. If the dialog box is placed before the authorization block of the program, then breakpoint stepping can be used to step over the else condition.

A solution to this problem is to return to subroutine before printing the error message. That way it is much harder to find the branch condition and override it.

A second security measure used is to make sure that the printer resolution is more than 200 dots per inch (dpi). The reason for requiring this higher resolution is to avoid the use of printer drivers that will generate fax resolution documents. If printing to a software fax machine were allowed, then it would be possible to print multiple times simply by recording the print file for the soft fax. Ensuring a resolution of greater than 200 dots per inch (dpi) invalidates printing to fax machine drivers, since fax resolution is 200 dpi. Most laser printers and inkjet cartridges are greater than 200 dpi. It should be emphasized that these security measures are ancillary measures that can provide a complement or alternative to the security features offered with issue lists and positive pay banking relationships with depository financial institutions.

As discussed above, electronic transmission of payment according to various aspects of the present invention can be employed to provide an electronically activated rebate. According to a further aspect of the present invention, a rebate can be activated without the need for a network connection or transmission of an electronic mail message.

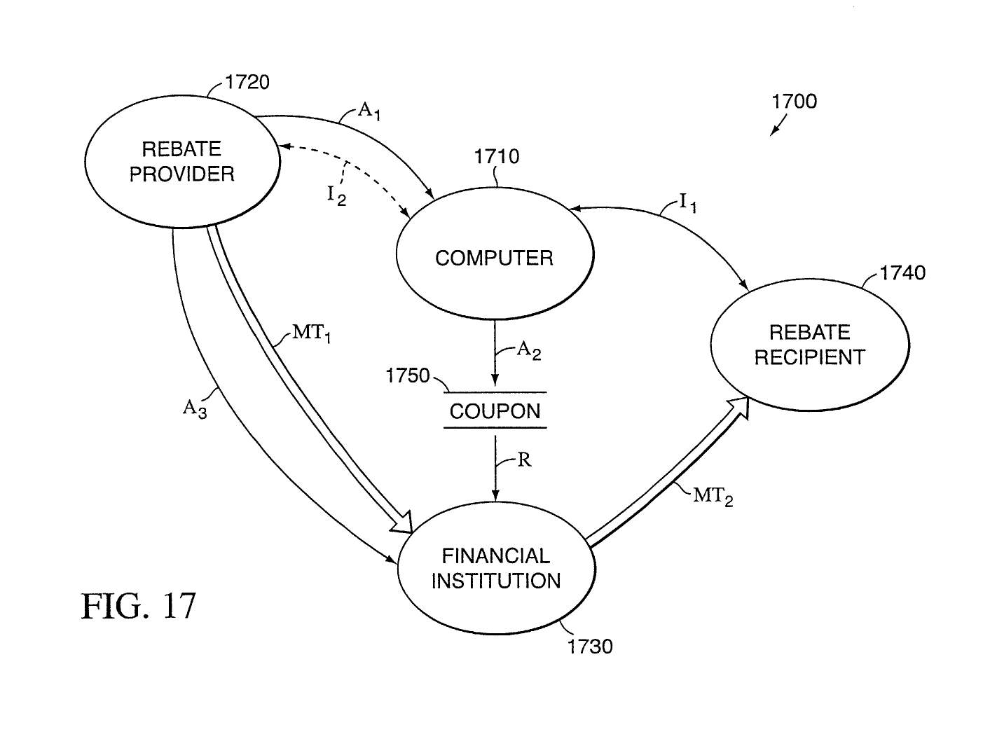

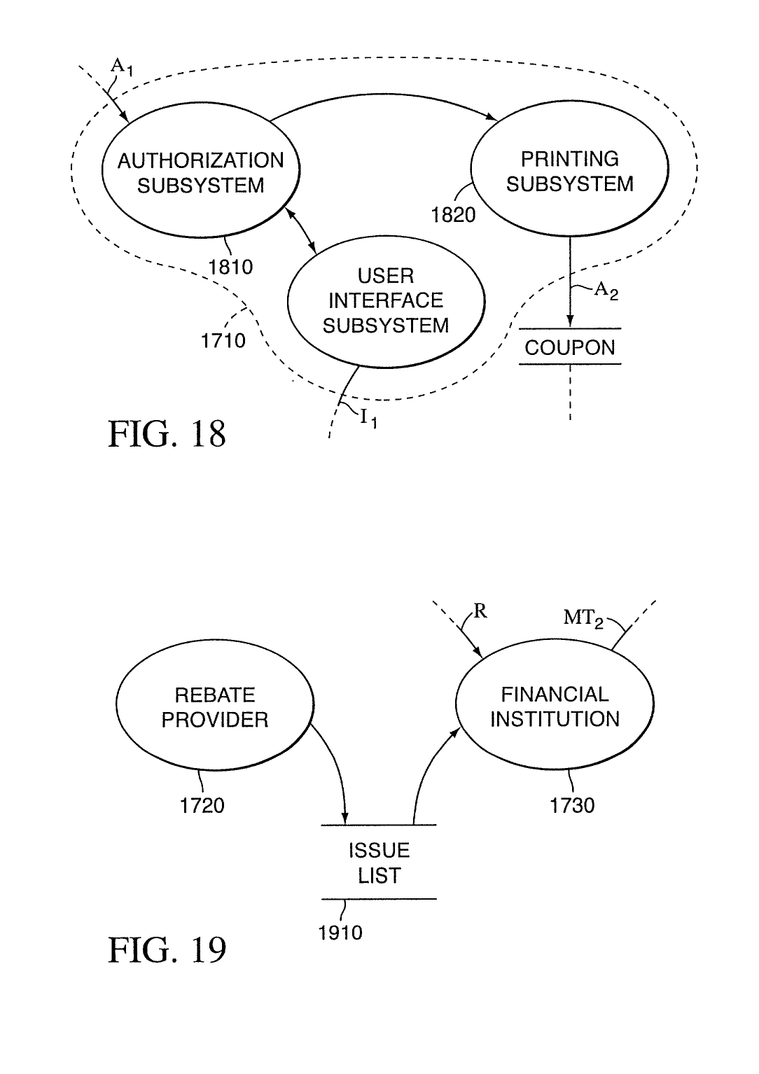

A rebate activation system according to various aspects of the present invention includes a computer system having an authorization subsystem and a printing subsystem. The system can further includes a rebate provider and a banking institution. For example, coupon activation system 1700 of FIG. 17 includes computer system 1710, rebate provider 1720, and financial institution 1730. As may be better understood with reference to FIG. 18, computer system 1710 includes authorization subsystem 1810, printing subsystem 1820, and a user interface subsystem 1830.

A computer system according to various aspects of the invention includes any suitable hardware and software for performing functions of an authorization subsystem, a printing subsystem, and a user interface subsystem. A printing subsystem according to the invention includes any suitable hardware and software/firmware for printing a coupon. An authorization subsystem according to the invention includes any suitable hardware and/or software for restricting printing of the coupon, or restricting validity of the coupon, under control of a rebate provider. Exemplary authorization subsystem 1810 and printing subsystem 1820 of computer system 1710 are discussed in greater detail below with respect to FIG. 18.

Computer system 1710 of exemplary system 1700 interacts with a rebate recipient 1740 via user interface subsystem 1830. This interaction is represented by dataflow line I1 in FIG. 17. A user interface subsystem can facilitate interaction with a user by any suitable user interface. For example, subsystem 1830 can interact with rebate recipient 1740 by a web browser running in a graphical user interface, with information communicated to rebate recipient 1740 via conventional output devices such as an LCD panel, CRT, voice synthesis subsystem, etc. and input communicated from rebate recipient 1740 via conventional input devices such as a mouse, keyboard, voice recognition subsystem, etc.

Rebate provider 1720 enters into a rebate transaction with rebate recipient 1740 through computer 1710. A rebate transaction according to various aspects of the present invention includes any mutually agreed performance of obligations by a user with compensation for such performance by a rebate. Illustrative examples of rebate transactions along with rebate providers and users likely to enter into such transactions are provided in TABLE III below.

TABLE III

| Rebate Provider | User | Rebate Transaction |
|---|---|---|
| Hardware product | Purchaser of | User agrees to accept |
| seller (e.g., E-Machines) | product | product and waive right |
| | | of return of product in |
| | | exchange for rebate. |
| Internet-based | Person subscribing | User agrees to subscribe |
| service provider | to Internet-based | to Internet-based service |
| | service | for a minimum sign-up |
| | | period in exchange for |
| | | rebate. |
| Internet-based | Person included in | User agrees to provide |
| polling agency | serving sample | realistic answers to |
| | | survey in exchange for |
| | | rebate. |
| Software seller | Purchaser of | User agrees to end-user |
| | software | license agreement |
| | | (EULA) of software, |
| | | waiving right of |
| | | return if agreement |
| | | requires such, in |
| | | exchange for rebate. |
| Piecework employer | Piecework | User provides electronic |
| requiring electronic | employee | work product (e.g., by |
| work product | providing electronic | uploading to rebate |
| | work product | provider's FTP site) in |
| | | exchange for rebate (i.e., |
| | | payment). |

Rebate provider 1720 authorizes computer 1710 (through authorization subsystem 1810) to generate a coupon 1750. This authorization, represented by dataflow line A1, may be of any suitable type. In one of many possible variations, rebate provider 1720 may provide a latent authorization for coupon generation by including appropriate software with other software provided to rebate recipient 1740. In such a variation, rebate provider 1720 delegates the responsibility to authorization subsystem 1810 to restrict coupon generation until the rebate transaction has been fulfilled. Ultimately, however, rebate provider 1720 must provide the authorization by providing the software to rebate recipient 1740 and thus delegating the responsibility to authorization subsystem 1810.

In a second variation, computer 1710 is in communication with rebate provider 1720 via a wide area network (e.g., the Internet) to obtain authorization from rebate provider 1720. In this second variation, the authorization is active; computer 1710 can only generate coupon 1750 after checking with rebate provider 1720 for authorization. Before providing authorization, rebate provider 1720 checks to see if the rebate transaction has been fulfilled (e.g., by inquiring computer 1710 as to whether a correct password has been entered, by receiving a subscription request via computer 1710, etc.). The dataflow line I2 represents the interaction between computer 1710 and rebate provider 1720 for active authorization. Interaction between rebate provider 1720 and rebate recipient 1740 (through computer 1710) may be understood as the series connection between dataflow lines I1 and I2.

A coupon according to various aspects of the present invention includes any medium bearing trusted indicia of payment obligation to the bearer of the medium. A coupon can be presented to an easily accessible banking institution for deposit to an account or for conversion to another types of demand note, e.g., United States currency. A coupon is preferably a printed document bearing distinctive indicia (e.g., a particular code, artwork, hidden information, etc.) that is trusted by such an institution. Examples of such types of coupons are money orders and personal checks.

Trusted indicia may have distinctive characteristics that would be difficult for a fraudulent user to counterfeit. An institution contemplating the acceptance of a coupon as payment may place trust in the coupon upon inspection of such characteristics. Alternatively, trusted indicia may bear a distinctive code that can be looked up in a registry of authorized payments such as an issue list. The operation of an issue list between a rebate provider and a banking institution is discussed below with reference to FIG. 19.

In variations where the benefits of a printed document are not required, a coupon may take the form of an electronic medium. An example of an electronic coupon is an e-mail message bearing distinctive characteristics in the form of a particular authentication key that would be recognized by a financial institution. An electronic coupon may also bear a distinctive code for looked up in a registry of authorized payments.

In exemplary system 1700, authorization subsystem 1810 communicates with rebate provider 1720 to determine whether it is authorized to permit printing subsystem 1820 to generate a coupon. Preferably, this communication occurs in a highly secure manner to prevent rebate recipient 1740 from deceiving authorization subsystem 1810 with a false authorization. For example, the authorization may take the form of a particular encrypted string that is interpreted by authorization subsystem 1810 by a predetermined set of rules. Such rules should be difficult for a user of computer system 1700 to figure out.

Upon authorization, computer 1710 generates printed coupon 1750 using printing subsystem 1820. Printing subsystem 1820 can include a conventional plain-paper printer (e.g., a laser printer) and printer driver software running on a personal computer. Printed coupon 1750 can be a sheet of plain paper bearing trusted indicia (e.g., an image formed from toner) that has been placed on the paper by the printer. The indicia can be formed using regular marking material (e.g., plain toner or ink) or material particularly suited for financial transactions (e.g., MICR toner). The dataflow line A2 represents the flow of authorization which results in coupon 1750.

Dataflow line R represents the authorization (i.e., trust) embodied in coupon 1750, when viewed by financial institution 1730. Upon placing trust in coupon 1750 (by trusted indicia, as discussed above), financial institution 1730 prepares to transfer funds from rebate provider 1720 to rebate recipient 1740. Transfer of funds from rebate provider 1720 to financial institution 1730 is represented by dataflow line MT1. Transfer of funds from financial institution 1730 to rebate recipient 1740 is represented by dataflow line MT2.

An exemplary process for transfer of funds may be better understood with reference to FIG. 19. Rebate provider 1720 provides and maintains an issue list 1910, which is accessible to financial institution 1730. When financial institution 1730 receives coupon 1750 with trusted indicia comprising a distinctive code, it looks up that code in issue list 1910. If rebate provider 1720 has authorized transfer of funds (i.e., activation of coupon 1750), the issue list entry corresponding to that distinctive code will be active. Financial institution 1730 will then transfer funds to rebate recipient 1740, typically by withdrawing funds from an account held by rebate provider 1720 and dispersing currency to rebate recipient 1740 for depositing funds an account held by rebate recipient 1740 (at the same banking institution or by transfer to a different one).

An embodiment of the invention providing particular advantages uses a “Scratch and Sniff” covering over a registration code. The registration code accompanies a product that consumer purchases. Text adjacent the covered-up registration code warns the consumer that uncovering the registration code and generating a coupon using that registration code will have certain consequences, e.g., waiving the right of return of the product. The rebate provider authorizes generation of a coupon (and hence payment of a rebate) upon receiving the registration code from the user. Receipt of the registration code evidences the user's uncovering it by removing the “Scratch and Sniff” covering, which is a conventional silver material of microscopic granules adhered together on a surface. Such material is commonly used in lottery tickets.

TABLE IV below lists U.S. patents whose detailed description portions (including referenced drawing figures) are incorporated herein by reference. Any terminology that may be clarified by a given reference is listed adjacent that reference or those references in TABLE IV. The detailed description portions (including referenced drawing figures) of any U.S. patent or U.S. patent application incorporated by reference into the patents listed in TABLE IV is also specifically incorporated herein by reference.

TABLE IV

| U.S. Patent(s) | Related Terminology |
|---|---|
| 5,870,725-“High volume | “Positive pay”-a service useful for |
| financial image media creation | authorization of funds transfer in |
| and display system and method” | the inventive system, where a file |
| 5,890,141-“Check alteration | of MICR information from the |
| detection system and method” | bank is electronically matched |
| | against a file of issued item |
| | information from the commercial |
| | customer. |
| 6,000,728-“Security document” | Trusted Indicia |
| 5,788,285-“Document protection | |
| methods and products” | |
| 5,118,109-“Instant poker game | “Scratch and Sniff” |
| card” | |

To illustrate operation of an embodiment of the invention, the following description is provided. This description is not to be considered limiting in any way, but merely exemplary. A product is offered for sale through retail or Internet channels offering an instant cashback rebate. The product is unpacked, installed, and software for the product is installed on a personal computer. After the installation process the software may send registration information (possibly over the internet) to the manufacturer. The product may use a “scratch'n sniff” registration code, in which the registration code is kept secret until the customer commits to purchasing the product and waives the right of return. For software products, this code can be printed on the inside of the sealed envelope containing the software. Once the envelope is opened, the software cannot be returned in most cases.

The rebate code enables printing of the rebate coupon. The coupon is preferably made out to the registered owner of the new product. It can be printed on plain paper or on check stock on a general purpose printer for a personal computer. A MICR or non-MICR toner cartridge can be used to print the money order. Security codes and patterns can be printed on the coupon to make it more difficult to copy. The type of markings found on standard check stock purchased from an office supply store can be employed. The rebate coupon can actually be an international money order, cashier's check, traveler's check, personal, company or corporate check, or beer draft. The financial instrument is processed just as any check or other item would be. The item clears the customer's bank and is passed to the bank of the financial instrument provider. Each day the provider's bank receives a list from the provider of the authorized items for payment, including their item number, payee name (if any), and item amount. If all of these parameters match an incoming item, then the transaction is approved. However, the item does not match the items in the issue list, then the item is returned as a stop payment to the customer bank or institution. In this way, fraud is largely eliminated.

For software download from the internet, the software is downloaded to a computer using an internet service provider, typically. The software is registered to the customer, and once the registration process has successfully been completed, a financial instrument is printed made out to the person who registered the software as a reward for successfully installing the software. The instrument is then cashed as in the preceding paragraph.

For becoming a member of an internet site, the customer visits the target site, reviews the information available and decides to become a member. He or she fills out the internet registration form, downloads the financial instrument printing software, and downloads information to print the customized money order on a local general-purpose printer for a personal computer. The financial instrument is cashed as would any other item at a local bank or institution.

To further illustrate uses of rebate coupon activation according to various aspects of the present invention, three specific examples are provided below. These examples are not to be considered limiting in any way, but merely exemplary.

The first example involves an E-machine that a consumer purchases. In the box with the e-machine software is an installation CD-ROM with registration software and instant rebate software. Also sent is a rebate code on a slip of paper with silver adhesive powder that must be scratched off to reveal the rebate code (scratch'n sniff rebate code). This paper says: “Revealing this code signifies your acceptance of this product and waives your right of return of the product.” The user plugs in the computer and hooks it up to his or her phone line. Product registration information is filled out in a form, and sent via phone line to the manufacturer. Once the registration process is complete, the computer asks for the rebate code, and then prints out the rebate money order made out to the registered owner in the amount of $75. If the rebate recipient's printer fails then the recipient can call the money order company and get a money order mailed. The money order is printed on any standard printer made for a personal computer on plain paper. The money order can be cashed at the customer's bank, as with any check.

The second example involves an internet company that wants to acquire new customers on the internet. This is normally a very expensive process. Even simple sites spend $20 per customer on marketing and sales costs. Online brokerages have valuations of up to $10,000 per customer. One method to acquire new customers is to offer them cash for signing up. E-Trade offered customers $50 to $75 for signing up as a new account. But it can take two months or longer to get these amounts credited to the customer's account.

In the example, the customer signs up on the internet for a new account. Any needed software is downloaded at that time. Once the signup process is completed, an internet money order is printed on the customer's printer for the amount of the incentive. If there is a minimum sign-up period, then the money order is forward-dated with a note that the account must be active when the money order is cashed for the money order to clear the bank.

The third example involves a large Internet company (e.g., America Online), which ships about a million CDs out to customers to get them to sign up as new members. This company offers 250 free hours of internet access during the first month of membership. In the example, the company can offer a $10 instant cash incentive for successfully installing the software on a computer that doesn't already have the software and using the service for 3 months. The money order prints out immediately on the user's printer, but is dated 90 days in the future to ensure that the customer is still signed up for the service at that time. If the user tries to cash the money order early, the item will not clear because it is forward dated. If the user discontinues the service and then tries to cash the money order, the item will not be approved because it is removed from the “positive pay” approved item list when the service is discontinued. Only if the customer waits the 90 days and still has signed up for the service will the item clear.

While the present invention has been described in terms of preferred embodiments and generally associated methods, the inventors contemplate that alterations and permutations thereof will become apparent to those skilled in the art upon a reading of the specification and study of the drawings. For example, the payor can be a company or other entity even though the payor has been largely discussed above as being an individual. In one of many possible instances where the payor is a company, a payee is a person who has purchased traveler's checks online in accordance with the invention and is owed “payment” of traveler's checks in denominations selected by the payee. The company issuing the traveler's checks (in this instance, the payor) transmits the traveler's checks as financial instruments to the payee even though the payee will probably not be the person actually cashing the checks. The payee can then print the checks using his or her own printer and either use them as payment for goods or (if they are no longer needed), present them for payment himself.

Accordingly, the present invention is not intended to be defined by the above description of preferred exemplary embodiments, or by the description present in the inventors' previously filed provisional application, which has been incorporated herein by reference. Rather, the present invention is defined variously by the issued claims. Each variation of the present invention is intended to be limited only by the recited limitations of its respective claim, and equivalents thereof, without limitation by terms not present therein. Further, the present invention is particularly pointed out and distinctly claimed using terminology that the inventors regard as having its broadest reasonable interpretation; the more specific interpretations of 35 U.S.C. § 112(6) are only intended in those instances where the term “means” is actually recited.

[image]

[image]

[image]

[image]

[image]

[image]

[image]

[image]

[image]

[image]

What is claimed is:

1. A method for electronically transmitting funds, the method comprising:
(a) establishing a connection between a first user terminal and a printer on a wide area network, wherein:
(1) the first user terminal is accessible to the payor;
(2) the printer is accessible to the payee; and
(3) the printer is configured to print substantially nonmagnetic printing media on a paper medium; and
(b) providing authorization input to the first user terminal to activate the printer to print a financial instrument on the paper medium, the financial instrument including indicia of (1) a financial account and (2) an amount of funds that the payee is authorized to draw from the financial account.

2. The method of claim 1 wherein the paper medium consists of standard office paper.

3. The method of claim 1 wherein the financial instrument is a rebate coupon.

4. The method of claim 1 wherein the financial instrument further includes indicia identifying the payee.

5. The method of claim 4 wherein the financial instrument is a personal check.

6. The method of claim 4 wherein the financial instrument is a traveler's check.

7. The method of claim 4 wherein the financial instrument is a money order.

8. The method of claim 1 wherein the financial instrument further includes indicia identifying an entity that owns funds of the financial account.

9. The method of claim 8 wherein the financial instrument further includes indicia of contact information for an authorized agent of the entity.

10. The method of claim 1 wherein the the financial instrument further includes security markings that are configured to change appearance when optically duplicated.

11. The method of claim 1 wherein the wide area network comprises the Internet.

12. The method of claim 11 wherein providing input at the first user terminal comprises:
(a) designating an electronic mail address of the payee; and
(b) conveying an electronic mail message to the payee, the message including an authorization code.

13. The method of claim 12 wherein providing input at the first user terminal further comprises attaching software to the electronic mail message, the software configured to activate the printer to print the financial instrument when executed.

14. The method of claim 11 further comprising establishing a connection between the printer and the first user terminal through a second user terminal, the second user terminal comprising a computer implementing a web browser.

15. The method of claim 11 wherein the connection between the first user terminal and the printer is established indirectly through a server of an intermediary entity that is coupled to the network.

16. The method of claim 15 wherein printing comprises:
(a) transmitting an authorization code to the second user terminal to signify payment of funds from the payor to the payee;
(b) relaying the authorization code from the second user terminal to the server to signify acceptance of payment by the payee; and
(c) printing the financial instrument under control of the server upon acceptance of the authorization code by the intermediary entity.

17. The method of claim 15 wherein printing further comprises downloading software from the server to the second user terminal, the software being configured to cause the financial instrument to be printed on the printer when in operation at the second user terminal.

18. The method of claim 17 wherein the software is further configured to allow only a single copy of the financial instrument to be printed on the printer.

19. The method of claim 17 wherein:
(a) the second user terminal implements functions of a web browser; and
(b) the software excecutes within a run-time environment of the web browser.

20. The method of claim 15 wherein:
(a) the intermediary entity controls funds of the financial account, including funds of the payor that are to be transmitted to the payee; and
(b) the indicia further includes identification of the intermediary entity.

21. The method of claim 15 further comprising transmitting, from the first terminal unit to the server of the intermediary entity, identification of the payment signified by the transmission of the authorization code, wherein the intermediary entity accepts the authorization code from the second terminal unit only if:
(a) the authorization code corresponds to the identification of the payment; and
(b) the intermediary entity has not previously permitted printing of the financial instrument.

22. The method of claim 1 further comprising:
(a) maintaining a list of payments of funds that one or more payees are authorized to draw, and have not yet drawn, from funds of the payor in the financial account; and
(b) after presentation of the financial instrument to a financial institution, permitting the payee to draw the funds indicated by the financial instrument from the financial account only if the list indicates that the payee is authorized to draw, and has not yet drawn, the funds.

23. A data structure for transmission as an electronic mail message to electronically transmit funds, the structure comprising:
(a) an electronic mail address of a payee; and
(b) an attachment of computer executable code configured to execute on a computer system of the payee to activate printing of a financial instrument on a printer accessible to the payee responsive to the authorization code, the financial instrument to include (1) indicia of a financial account and (2) an amount of funds that the payee is authorized to draw from the financial account.

24. A method for electronically transmitting funds, the method comprising:
(a) designating an electronic mail address of a payee;
(b) conveying an electronic mail message to the payee, the message including an authorization code; and
(c) activating printing of a financial instrument on a printer accessible to the payee responsive to the authorization code, the financial instrument including (1) indicia of a financial account and (2) an amount of funds that the payee is authorized to draw from the financial account.

25. The method of claim 24 wherein the printer is configured to print substantially nonmagnetic printing media on a paper medium.

26. The method of claim 25 wherein the paper medium consists of standard office paper.

27. The method of claim 24 wherein the financial instrument is a rebate coupon.

28. The method of claim 24 wherein the financial instrument further includes indicia identifying the payee.

29. The method of claim 28 wherein the financial instrument is a personal check.

30. The method of claim 28 wherein the financial instrument is a traveler's check.

31. The method of claim 28 wherein the financial instrument is a money order.

32. The method of claim 24 wherein the financial instrument further includes indicia identifying an entity that controls funds of the financial account.

33. The method of claim 32 wherein the financial instrument further includes indicia of contact information for an authorized agent of the entity.

34. The method of claim 24 wherein the financial instrument further includes security markings that are configured to change appearance when optically duplicated.

35. The method of claim 24 wherein activating printing comprises relaying the authorization code from the payee to a server of an intermediary entity to signify acceptance of payment by the payee.

36. The method of claim 35 wherein:
(a) activating printing further comprises downloading software from the server to the second user terminal to signify a guarantee by the intermediary of the availability of the funds; and
(b) the software is configured to cause the the printer to print the financial instrument during operation of the software at the second user terminal.

37. The method of claim 35 wherein the software is further configured to allow only a single copy of the financial instrument to be printed on the printer.

38. The method of claim 35 wherein:
(a) the second user terminal implements functions of a web browser; and
(b) the software excecutes within a run-time environment of the web browser.

39. The method of claim 35 wherein:
(a) the intermediary entity controls funds of the financial account, including funds of the payor that are to be transmitted to the payee; and
(b) the indicia further includes identification of the intermediary entity.

40. The method of claim 35 further comprising transmitting, from the first terminal unit to the server of the intermediary entity, identification of the payment signified by the transmission of the authorization code, wherein the intermediary entity accepts the authorization code from the second terminal unit only if:
(a) the authorization code corresponds to the identification of the payment; and
(b) the intermediary entity has not previously permitted printing of the financial instrument.

41. The method of claim 24 further comprising:
(a) maintaining a list of payments of funds that one or more payees are authorized to draw, and have not yet drawn, from funds of the payor in the financial account; and
(b) after presentation of the financial instrument to a financial institution, permitting the payee to draw the funds indicated by the financial instrument from the financial account only if the list indicates that the payee is authorized to draw, and has not yet drawn, the funds.

42. A system for operation by a payee to electronically receive funds transmitted by a payor remotely located from the payee, the system comprising:
(a) a printer configured to print substantially nonmagnetic printing media on a paper medium;
(b) a network communication subsystem coupling the printer to a first user terminal on a wide area network, the first user terminal being remote from the printer; and
(c) an authorization subsystem responsive to authorization input conveyed from the first user terminal to activate the printer to print a financial instrument on the paper medium, the financial instrument including indicia of (1) a financial account and (2) an amount of funds that the payee is authorized to draw from the financial account.

43. A method for electronically transmitting a rebate to a user, the method comprising:
(a) offering a rebate to the user in consideration for performance of an obligation of a specified rebate transaction;
(b) receiving information from the user confirming performance of the obligation; and
(c) upon performance of the obligation, generating a rebate coupon, the rebate coupon including a medium bearing trusted indicia of payment obligation to the bearer of the medium.

44. The method of claim 43 wherein:
(a) the specified rebate transaction includes an agreement by the user to accept specific terms for use of a product or service; and
(b) performance of the obligation includes performance by the user of an action intended to legally bind the user to the agreement.

45. The method of claim 44 wherein the action intended to legally bind the user includes removing opaque material to reveal a code printed on a tangible medium.

46. The method of claim 44 wherein the terms include payment by the user to receive a service for a predetermined period.

47. The method of claim 44 wherein the terms include waiving the right to return a product purchased by the user.

48. The method of claim 44 wherein the terms include purchase by the user of a non-refundable license to a software product.

49. The method of claim 48 wherein the action intended to legally bind the user includes installing the software product.

50. The method of claim 43 wherein:
(a) the rebate coupon is generated by printing on a general-purpose printer accessible to the user; and
(b) the trusted indicia consists substantially of substantially nonmagnetic visual indicia formed on a plain paper medium by the printer, the indicia including:
(1) identification of a financial account containing funds of the rebate; and
(2) an amount of funds that are authorized to the drawn from the financial account as the rebate.

51. The method of claim 50 wherein the indicia further includes identification of the user as payee of the rebate.

52. The method of claim 50 wherein the indicia further includes identification of an entity that controls funds of the financial account.

53. The method of claim 50 wherein the indicia further includes security markings that are configured to change appearance when optically duplicated.

54. The method of claim 50 wherein printing comprises:
(a) coupling a server of an intermediary entity to the user terminal;
(b) transmitting an authorization code to the user terminal to signify payment of the rebate to the user;
(c) relaying the authorization code from the user terminal to the server to signify submission of the rebate by the user; and
(d) printing the financial instrument under control of the server upon acceptance of the authorization code by the intermediary entity.

55. The method of claim 54 wherein:
(a) activating printing further comprises downloading software from the server to the second user terminal to signify a guarantee by the intermediary of the availability of the funds; and
(b) the software is configured to cause the the printer to print the rebate coupon during operation of the software at the second user terminal.

56. The method of claim 55 wherein the software is further configured to allow only a single copy of the rebate coupon to be printed on the printer.

57. The method of claim 55 wherein:
(a) the second user terminal implements functions of a web browser; and
(b) the software executes within a run-time environment of the web browser.

58. The method of claim 54 wherein:
(a) the intermediary entity controls funds of the financial account, including funds of the rebate that are to be transmitted to the user; and
(b) the indicia further includes identification of the intermediary entity.

59. The method of claim 54 further comprising transmitting, from the first terminal unit to the server of the intermediary entity, identification of the payment signified by the transmission of the authorization code, wherein the intermediary entity accepts the authorization code from the second terminal unit only if:
(a) the authorization code corresponds to the identification of the payment; and
(b) the intermediary entity has not previously permitted printing of the rebate coupon.

60. The method of claim 43 further comprising:
(a) maintaining a list of payments of funds that one or more payees are authorized to draw, and have not yet drawn, from funds of the rebate in the financial account; and
(b) after presentation of the financial instrument to a financial institution, permitting the user to draw the funds indicated by the rebate coupon from the financial account only if the list indicates that the user is authorized to draw, and has not yet drawn, the funds.

61. An Internet server for electronically conveying funds from a payor to a payee, the server comprising:
(a) a user interface subsystem that, in operation, requests payment information from the payor, the requested information to include:
(1) an electronic mail address of the payee; and
(2) an amount of funds that the payee is authorized to draw from the financial account;
(b) an electronic mail subsystem responsive to the electronic mail address to transmit an electronic mail message to the payee, the message including an authorization code; and
(c) an authorization subsystem responsive to a copy of the authorization code from the payee to transmit computer executable code to the payee, the code being configured to execute on a computer system of the payee to activate printing of a financial instrument on a printer accessible to the payee responsive to the authorization code, the financial instrument to include (1) indicia of a financial account and (2) an amount of funds that the payee is authorized to draw from the financial account.
